(19) United States
(12) Patent Application Publication
(10) Pub. No.: US 2006/0098722 A1
(43) Pub. Date: May 11, 2006

(54) Repeating installation, communication speed adjusting method, program, and recording medium

(76) Inventors: Osamu Tanaka, Osaka (JP); Tomonori Shiomi, Osaka (JP); Akihiro Tatsuta, Kyoto (JP); Hiroyuki Watanabe, Osaka (JP); Nobuhiko Arashin, Osaka (JP); Masahiko Nagoshi, Osaka (JP)

Correspondence Address: RATNERPRESTIA, P.O. BOX 980, VALLEY FORGE, PA, 19482, US

(21) Appl. No.: 11/270,306

(22) Filed: Nov. 9, 2005

(30) Foreign Application Priority Data
Nov. 9, 2004 (JP) 2004-324773

(51) Int. Cl. H04B 3/36; H04L 25/00

(52) U.S. Cl. 375/211; 375/225; 375/257

(57) ABSTRACT

A repeating installation includes transmission speed detection units which detect respective transmission speeds of a plurality of transmission lines connected to a plurality of communication apparatuses, a transmission speed determination unit which determines the slowest transmission speed among the detected transmission speeds of respective transmission lines as a reference transmission speed, a transmission speed adjusting unit which adjusts a transmission speed of a transmission line, whose detected transmission speed is faster than the reference transmission speed, so as to become a speed equal to or slower than the reference transmission speed, and the like.

### BACKGROUND OF THE INVENTION

1. Field of the Invention

The present invention relates to a repeating installation which performs data relay between apparatuses connected to transmission lines at different transmission speeds, a communication speed adjusting method, and the like.

2. Related Art of the Invention

Recently, because of rapid spread of the Internet, users of receiving picture data using the Internet, storing it in a server, and viewing and listening to picture data with a plurality of other personal computers and AV equipment have also increased. At that time, there might be a case that a type of the transmission line the connected to audio-visual equipment differed from that of the transmission line from the server in an apparatus which relays data between the server and a plurality of audio-visual equipment. For example, it is a case that one transmission line is 100-Mbps Ethernet (registered trademark) (100BASE-TX), and another transmission line is a 54-Mbps wireless LAN (IEEE 802.11a). When types of transmission lines differ, transmission speeds of data which flow through those transmission lines also differ.

Hereafter, an embodiment in regard to a repeating installation which performs data relay between apparatuses connected to conventional transmission lines at different transmission speeds will be explained with referring to drawings.

FIG. 5 is a structural diagram of a conventional repeating installation which performs data relay between apparatuses connected to transmission lines at different transmission speeds.

FIG. 5 shows transmission lines 511 and 512, receiving units 521 and 522 which receive data from the transmission lines 511 and 512 respectively, and transmitting units 531 and 532 which transmit data to the transmission lines 511 and 512. In addition, a speed absorption buffer unit 541 serves to data which is received from the transmission line 511 and is transmitted to the transmission line 512, and a speed absorption buffer unit 542 serves to data which is receive from the transmission line 512 and is transmitted to the transmission line 511.

Hereafter, operation of the conventional repeating installation which relays data received from the transmission line 511 to the transmission line 512 between apparatuses connected to the transmission lines 511 and 512 at different transmission speeds will be explained. However, transmission and reception processing time in the repeating installation shall not be taken into consideration. Here, let the transmission speed of the transmission line 511 be 1 Gbps and let the transmission speed of the transmission line 512 be 100 Mbps, as an example.

The repeating installation receives relay data from the transmission line 511 in the receiving unit 521. The transmission speed of the transmission line 511 is 1 Gbps and the transmission speed of the transmission line 512 is 100 Mbps, and hence, the transmission speed of the transmission line 511 is faster than that of the transmission line 512. Hence, the received data is once stored in the speed absorption buffer unit 541 so as to transmit the data to the transmission line 512 from the transmitting unit 532.

The data stored in the speed absorption buffer unit 541 is transmitted to the transmission line 512 at the transmission speed of the transmission line 512 from the transmitter 532 which transmits data to the transmission line 512.

In addition, transmission and reception processing time in the repeating installation is not taken into consideration. Hence, when the transmission speeds of the transmission line 511 and transmission line 512 are the same, or when the transmission line 511 is slower than the transmission speed of the transmission line 512, data is not stored in the speed absorption buffer unit 541.

Thus, it is possible to perform data relay between apparatuses connected to transmission lines at different transmission speeds by a repeating installation using speed absorption buffer memory which absorbs speed difference between the transmission speeds of respective transmission lines.

Furthermore, a method of audio-visual equipment giving a measurement request of a data processing speed between a server and the audio-visual equipment (both of server-to-repeating-installation and repeating-installation-to-audio-visual-equipment) to a measurement server while requesting relay data of the server, and the measurement server measuring actual measurements of data transfer rates of transmission lines as physical speeds, and performing speed setting to the server and audio-visual equipment on the basis of the measuring result is also proposed (for example, refer to Japanese Patent Laid-Open No. 2004-129205).

Nevertheless, when performing data relay between the apparatuses connected to transmission lines at different transmission speeds, a repeating installation absorbs speed difference between the transmission lines by speed absorption buffer memory. Hence, memory quantity which enables the absorption increases in accordance with expansion of the speed difference.

In addition, speed absorption buffer memory becomes necessary every transmission line as the number of transmission lines increases.

Furthermore, in the case of the method proposed in the above-mentioned reference, in order to measure a physical speed of a transmission line before data transmission, a measuring server which measures the physical speed is needed besides a repeating installation.

The present invention solves the conventional subjects mentioned above, and aims at providing a repeating installation, a communication speed adjusting method, and the like which make speed absorption buffer memory unnecessary or can reduce required speed absorption buffer memory to the minimum capacity, and can be implemented in simple structure.

### SUMMARY OF THE INVENTION

The 1^{st} aspect of the present invention is a repeating installation, comprising:

a transmission speed detection unit detecting respective transmission speeds of a plurality of transmission lines connected to a plurality of communication apparatuses;

a transmission speed determination unit determining a slowest transmission speed among the transmission speeds of the respective transmission lines, which are detected, as a reference transmission speed; and

a transmission speed adjusting unit adjusting a transmission speed of a transmission line, when a detected transmission speed is faster than the reference transmission speed, so as to become a speed equal to or slower than the reference transmission speed.

The 2^{nd} aspect of the present invention is the repeating installation according to the 1^{st} aspect of the present invention, further comprising:

a transmission speed determination and selection unit which selects combination, in which communication among any communication apparatuses of the plurality of communication apparatuses connected by the plurality of transmission lines to each other is performed, wherein the transmission speed determination unit determines the reference transmission speed for every combination selected; and

wherein the transmission speed adjusting unit adjusts a transmission speed of a transmission line whose detected transmission speed differs from the reference transmission speed for every combination selected.

The 3^{rd} aspect of the present invention is the repeating installation according to the 1^{st} aspect of the present invention, wherein the transmission speed adjusting unit adjusts a transmission speed of a transmission line, when a detected transmission speed is faster than the reference transmission speed, at a fastest speed among speeds which is equal to or slower than the reference transmission speed and is settable.

The 4^{th} aspect of the present invention is the repeating installation according to the 1^{st} aspect of the present invention, wherein the transmission speed detection unit redetermines the reference transmission speed from transmission speeds of respective transmission lines which are connected, at predetermined timing, and adjusts a transmission speed so as to become a speed equal to or slower than the reference transmission speed when there is a transmission line whose transmission speed is faster than the reference transmission speed.

The 5^{th} aspect of the present invention is the repeating installation according to the 4^{th} aspect of the present invention, wherein the predetermined timing is a time of the number of connections or type of the plurality of transmission lines changing.

The 6^{th} aspect of the present invention is the repeating installation according to the 1^{st} aspect of the present invention, wherein each communication system of the plurality of transmission lines has anyone of ethernet, a coaxial cable, a power line, wireless, IEEE 1394, a USB, Bluetooth, and a PNA.

The 7^{th} aspect of the present invention is an information processing apparatus, comprising:

connecting means of connecting a plurality of transmission lines; and

relay means of relaying the connecting means mutually, and including:

the repeating installation according to the 1^{st} aspect of the present invention as the relay means.

The 8^{th} aspect of the present invention is a communication speed adjusting method, comprising:

a transmission speed detection step of detecting respective transmission speeds of a plurality of transmission lines connected to a plurality of communication apparatuses;

a transmission speed determination stop of determining a slowest transmission speed among the transmission speeds of the respective transmission lines, which are detected, as a reference transmission speed; and

a transmission speed adjusting step of adjusting a transmission speed of a transmission line, when a detected transmission speed is, faster than the reference transmission speed, so as to become a speed equal to or slower than the reference transmission speed.

The 9^{th} aspect of the present invention is a recording medium which can be treated by a computer and is a recording medium recording a program for making the computer function for executing: the transmission speed detection step of detecting respective transmission speeds of a plurality of transmission lines connected to a plurality of communication apparatuses; the transmission speed determination step of determining a slowest transmission speed among the transmission speeds of the respective transmission lines, which are detected, as a reference transmission speed; and the transmission speed adjusting step of adjusting a transmission speed of a transmission line, where a detected transmission speed is faster than the reference transmission speed, so as to become a speed equal to or slower than the reference transmission speed of the communication speed adjusting method according to the 8^{th} aspect of the present invention.

The present invention can provide a repeating installation, a communication speed adjusting method, and the like which make speed absorption buffer memory unnecessary or can reduce required speed absorption buffer memory to the minimum capacity, and can be implemented in simple structure.

### BRIEF DESCRIPTION OF THE DRAWINGS

FIG. 1 is a block diagram of a repeating installation according to a first embodiment of the present invention;

FIG. 2 is a block diagram of a repeating installation according to a second embodiment of the present invention;

FIG. 3 is a block diagram of a repeating installation according to a third embodiment of the present invention;

FIG. 4(A) is a drawing showing an example of utilization of an information processing apparatus using the repeating installation of the present invention;

FIG. 4(B) is a drawing showing an example of utilization of an information processing apparatus using the repeating installation of the present invention; and

FIG. 5 is a structural diagram of a repeating installation which is a conventional example and performs data relay between apparatuses connected to transmission lines at different transmission speeds.

### DESCRIPTION OF SYMBOLS

111 to 113, 211 to 215, 411, and 412: Transmission lines
121 to 123, 231 to 235: Transmission speed detection units
124 to 126, 236 to 240: Transmission speed converting units
13 and 24: Transmission speed determination units
14, 25, and 31: Transmission speed adjusting units
22: Transmission speed determination and selection unit
26: Switching unit
521 and 522: Receiving units
531 and 532: Transmitting units
541 and 542: Speed absorption buffer units

### DETAILED DESCRIPTION OF THE PREFERRED EMBODIMENTS

Hereafter, embodiments of the present invention will be described with referring to drawings.

### Embodiment 1

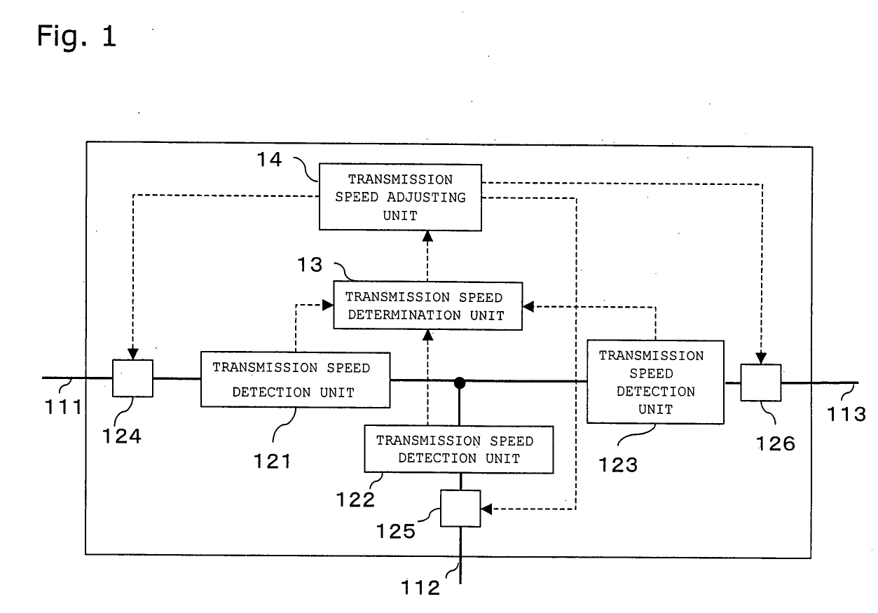

FIG. 1 is a block diagram of a repeating installation according to a first embodiment of the present invention.

In FIG. 1, transmission lines 111 to 113 are connected to a plurality of communication apparatuses and transmission speed detection units 121 to 123 detect transmission speeds of the transmission lines 111 to 113, respectively. A transmission speed determination unit 13 determines a slowest transmission speed among transmission speeds of transmission lines with the communication apparatuses detected by respective transmission speed detection units 121 to 123. A transmission speed adjusting unit 14 adjusts transmission speeds of transmission lines to the transmission lines other than the transmission line at the slowest transmission speed determined in the transmission speed determination unit 13 so as to perform communication at the slowest transmission speed. In addition, transmission speed converters 124 to 126 interface as interfaces the repeating installation and transmission lines 111 to 113, and convert transmission speeds of the respective transmission lines 111 to 113 on the basis of an adjustment signal from the transmission speed adjusting unit 14. Furthermore, as for the transmission lines 111 to 113, unique transmission speeds are set according to their standards and types, respectively.

Moreover, continuous lines shown in the drawing show data flows between a plurality of communication apparatuses connected to the transmission lines 111 to 113, and short dashes lines show flows of information, signals, and the like between respective blocks in the repeating installation of this first embodiment except the data between communication apparatuses. In addition, in the above-mentioned structure, the transmission speed adjusting unit 25 and the transmission speed converters 124 to 126 constitute the transmission speed adjusting unit of the present invention.

Next, operation of the repeating installation of this first embodiment which performs relay between apparatuses connected to transmission lines at different transmission speeds will be explained.

When the transmission lines 111 to 113 with communication apparatuses are connected to the repeating installation of this first embodiment, the transmission speed detection units 121 to 123 detect the transmission speeds of the transmission lines 111 to 113 with a plurality of connected communication apparatuses. At this time, as a detection method of the transmission speeds of the transmission lines in the transmission speed detection units 121 to 123, for example, a detection signal of a chip for Ethernet can be used. However, a detection method of a transmission speed of each transmission line is not limited to this method, but it may be sufficient even if it is any other method.

Hereafter, let the transmission speed of the transmission lines 111 and 113 be 1 Gbps and let the transmission speed of the transmission line 112 be 100 Mbps, as an example of the detection result.

And, when acquiring all the transmission speeds of transmission lines with the communication apparatuses which the respective transmission speed detection units 121 to 123 detect, the transmission speed determination unit 13 determines a slowest transmission speed among these as a reference transmission speed (in this example, 100 Mbps of the transmission speed of the transmission line 112).

Next, the transmission speed adjusting unit 14 outputs an adjustment signal, which adjusts transmission speeds of transmission lines (in this example, the transmission lines 111 and 113), to the transmission speed converters 124 to 126 respectively so that the transmission lines (in this example, the transmission lines 111 and 113) other than the transmission speed determined as the reference transmission speed by the transmission speed determination unit 13 may communicate at the reference transmission speed (in this example, 100 Mbps). At this time, the transmission speed converters 124 to 126 are achieved as interface portions which connect respective transmission lines and a body of the repeating installation, and conversion of speeds is performed as changes of speed setting of driver software which respective interfaces have. For example, initialization of interfaces is performed by making the transmission speed converters 124 and 126 perform negotiation so as to perform connection fixed at 100 Mbps. However, the adjusting method of transmission speeds of transmission lines is not limited to this method, but it may be sufficient even if it is any other method.

As described above, according to the repeating installation of this first embodiment, when a transmission line is connected, a transmission speed is detected, a slowest transmission speed is determined, and transmission speeds of transmission lines are adjusted in transmission lines other than the transmission line so as to communicate at the slowest transmission speed, it becomes possible to reduce the speed absorption buffer memory, and to perform stable data communication even for data such as picture data, in which a data dropout is impermissible.

### Embodiment 2

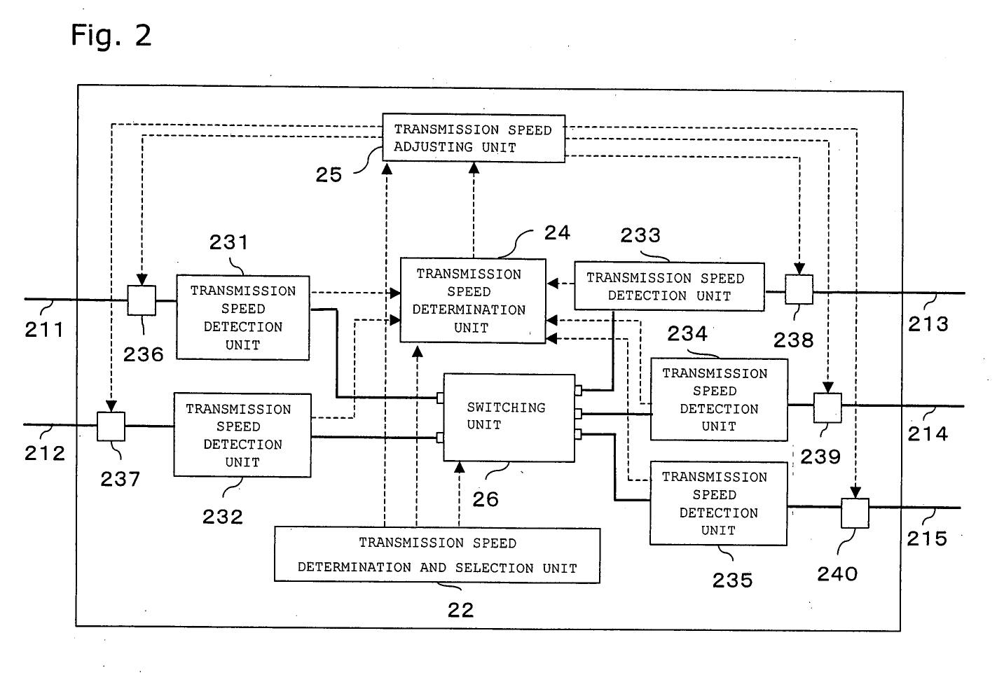

FIG. 2 is a block diagram of a repeating installation according to a second embodiment of the present invention.

In FIG. 2, transmission lines 211 to 215 are connected to a plurality of communication apparatuses and transmission speed detection units 231 to 235 detect transmission speeds of the transmission lines 211 to 215, respectively. A transmission speed determination and selection unit 22 selects combination of transmission lines whose transmission speed are determined.

A transmission speed determination unit 24 determines a slowest transmission speed for the transmission speed of the transmission line selected by the transmission speed determination and selection unit 22 among the transmission lines 211 to 215. A transmission speed adjusting unit 25 adjusts transmission speeds of transmission lines to the transmission lines other than the transmission line at the slowest transmission speed, determined in the transmission speed determination unit 24, among the transmission lines, selected by the transmission speed determination and selection unit 22, so as to perform communication at the slowest transmission speed. In addition, transmission speed converters 236 to 240 interface as interfaces the repeating installation and transmission lines 211 to 215, and convert transmission speeds of the respective transmission lines 211 to 215 on the basis of an adjustment signal from the transmission speed adjusting unit 14.

And, a switching unit 26 switches connection between respective transmission lines so that data can be transmitted and received between the transmission lines in the combination selected by the transmission speed determination and selection unit 22.

Next, operation of the repeating installation of this second embodiment which performs relay between apparatuses connected to transmission lines at different transmission speeds will be explained.

When the transmission lines 211 to 215 with communication apparatuses are connected to the repeating installation of this second embodiment, the transmission speed detection units 231 to 235 detect the transmission speeds of the transmission lines 211 to 215 with a plurality of connected communication apparatuses. As an example of the detection result, let the transmission speed of the transmission lines 211 and 212 be 1 Gbps and let the transmission speed of the transmission line 213 be 10 Mbps. Let the transmission speed of the transmission lines 214 and 215 be 100 Mbps.

The transmission speed determination and selection unit 22 passes information on the combination of the transmission lines, connected to communication apparatuses communicating mutually, to each of the transmission speed determination unit 24, transmission speed adjusting unit 25, and switching unit 26. In this example, communications shall be mutually performed in respective combinations among the transmission lines 211, 213, and 215, and between the transmission lines 212 and 214.

According to the combination information on the transmission line received from the transmission speed determination and selection unit 22, the switching unit 26 performs connection so that data can be transmitted and received among respective transmission lines. In this example, the switching unit 26 performs connection communications may be mutually performed in respective combinations between the transmission lines 212 and 214, and among the transmission lines 211, 213, and 215.

Then, according to the combination information on the transmission lines received from the transmission speed determination and selection unit 22, for every combination, the transmission speed determination unit 24 determines a slowest transmission speed among transmission speeds of transmission lines with the communication apparatuses which are detected by respective transmission speed detection units 221 to 225 as a reference transmission speed. In this example, they are 10 Mbps in the combination of the transmission lines 211, 213, and 215 (hereafter, combination (A)), and 100 Mbps in the combination of the transmission lines 212 and 214 (hereafter, combination (B)).

Next, according to the combination information on the transmission lines received from the transmission speed determination and selection unit 22, the transmission speed adjusting unit 25 determines a reference transmission speed for every combination.

The transmission speed adjusting unit 25 adjusts the transmission speed of each transmission line for each of the transmission line 211 of the combination (A) and the transmission lines 212 and 214 of the combination (B), which are transmission lines other than the transmission speed determined as the reference transmission speed by the transmission speed determination unit 24, so as to communicate at the slowest transmission speed in the transmission lines selected in the transmission speed adjusting unit 25.

In this example, the transmission speed converters 236, 237, and 239 are given conversion control so as to become 10 Mbps of transmission speed in the combination (A) and 100 Mbps of transmission speed in the combination (B).

In addition, although all the transmission speed detection units 231 to 235 detect transmission speeds of transmission lines in the repeating installation of this second embodiment, it is also sufficient to pass information on the combinations of transmission lines selected by the transmission speed determination and selection unit 22 to respective transmission speed detection units 231 to 235, and for only the transmission speed detection units 231 to 235 of the selected transmission lines to detect the transmission speeds of the transmission lines.

As described above, according to the repeating installation of this second embodiment, when a transmission line is connected, a transmission speed is detected, a slowest transmission speed is determined every combination of the selected transmission lines, and transmission speeds of transmission lines are adjusted in transmission lines other than the transmission line so as to communicate at the slowest transmission speed, it becomes possible to perform stable data communication even for data such as picture data, in which a data dropout is impermissible, at optimum transmission speeds between respective apparatuses with reducing the speed absorption buffer memory.

### Embodiment 3

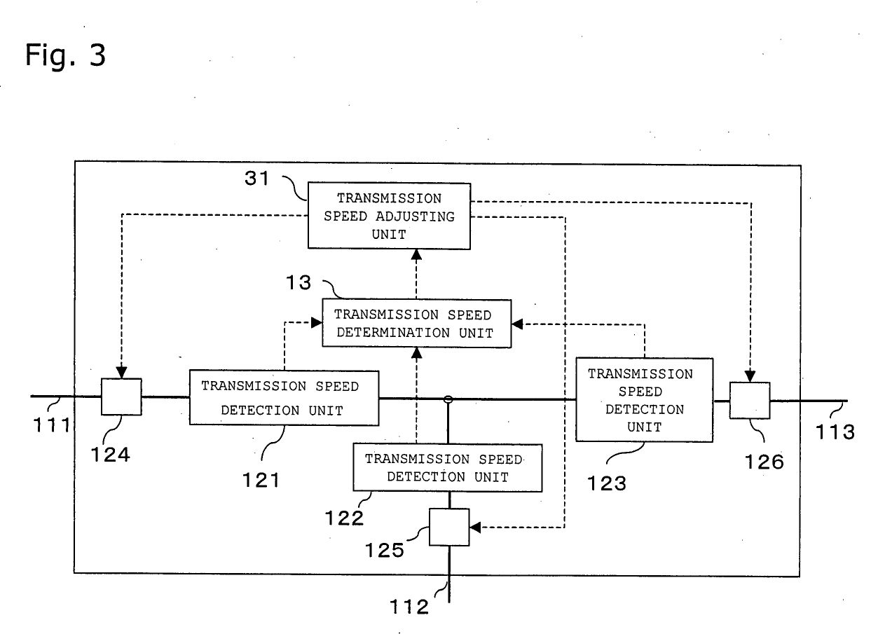

FIG. 3 is a block diagram of a repeating installation according to a third embodiment of the present invention. In addition, the same reference numerals are applied to the same components as those in the repeating installation of the first embodiment, and their explanation is omitted.

Difference from the repeating installation of the first embodiment shown in FIG. 1 is only a transmission speed adjusting unit 31, and other structure is the same as that of the first embodiment.

In FIG. 3, the transmission speed adjusting unit 31 adjusts transmission lines other than the transmission line at the slowest transmission speed, which is determined as the reference transmission speed by the transmission speed determination unit 13, at a transmission speed which is close to the reference transmission speed and settable so as to communicate at the reference transmission speed or slower.

Hereafter, operation of the repeating installation of this third embodiment which performs relay between apparatuses connected to transmission lines at different transmission speeds will be explained.

When the transmission lines 111 to 113 with communication apparatuses are connected to the repeating installation of this third embodiment, the transmission speed detection units 121 to 123 detect the transmission speeds of the transmission lines 111 to 113 with a plurality of connected communication apparatuses. As an example of the detection result, let the transmission speed of the transmission lines 111 and 113 be 100 Mbps and settable transmission speeds be 100 Mbps and 10 Mbps, and let the transmission speed of the transmission line 112 be 11 Mbps and settable transmission speeds be 11 Mbps and 2 Mbps.

Then, the transmission speed determination unit 13 determines a slowest transmission speed among transmission speeds of transmission lines with the communication apparatuses detected by respective transmission speed detection units 121 to 123 as a reference transmission speed. In this example, it is 11 Mbps of transmission speed of the transmission line 112.

Next, the transmission speed adjusting unit 31 adjusts transmission speeds of transmission lines at a transmission speed, which is close to the reference transmission speed and settable, so that the transmission lines (in this example, the transmission lines 111 and 113) other than the transmission speed determined as the reference transmission speed by the transmission speed determination unit 13 may communicate at the reference transmission speed (in this example, 11 Mbps) or slower. Thus, it is adjusted at a fastest transmission speed among transmission speeds which are settable in the range of the reference transmission speed and slower (10 Mbps in this example).

As described above, according to the repeating installation of this third embodiment, when a transmission line is connected, a transmission speed is detected, a slowest transmission speed is determined, and transmission speeds of transmission lines are adjusted in transmission lines other than the transmission line so as to communicate at a transmission speed which is close to the slowest transmission speed and settable, it becomes possible to minimize the speed absorption buffer memory, and to perform stable data communication even for data such as picture data, in which a data dropout is impermissible.

In addition, in the above-mentioned first and third embodiments, although the transmission speed determination unit 13 determines a slowest transmission speed as a reference transmission speed from among these after detecting all the transmission speeds of the transmission lines 111 to 113, it is not necessary to always perform simultaneously the operation of transmission speed detection of the transmission speed detection units 121 to 123. It is also sufficient that, when a user connects the transmission lines 111 to 113 in arbitrary turn, transmission speeds are detected one by one every connection of each transmission line, and when a predetermined time elapses after a transmission speed of a transmission line which is connected finally is detected, the transmission speed determination unit 13 determines the reference transmission speed for the first time.

Furthermore, in the above-mentioned operation, it is made that the transmission speed determination unit 13 determines a reference transmission speed from among transmission speeds of these transmission lines in a state that the transmission lines 111 to 113 are connected, and the transmission speed adjusting unit 14 or 31 adjusts transmission speeds of respective transmission lines 111 to 113 so as to fit to this. Nevertheless, it is also sufficient to adopt the structure that, when the number or type of transmission lines which are connected to the repeating installation changes, the transmission speed determination unit 13 determines a new reference transmission speed at the timing, and the transmission speed adjusting unit 14 or 31 adjusts again the transmission speeds of respective transmission lines 111 to 113 so as to fit to this.

For example, when the transmission line 112 is removed from the structure of FIGS. 1 and 3, the transmission speed determination unit 13 measures again each transmission speed of the transmission line 111 and transmission line 113, which are connected now, by making the transmission speed detection unit 121 detecting communicative stoppage as a trigger. From the above-described examples, since any of the transmission speeds of the transmission lines 111 and 113 is 1 Gbps, the transmission speed adjusting unit 14 or 31 controls the transmission speed converters 125 and 126, and makes the transmission speed of the transmission lines 111 and 113 change to 1 Gbps from 100 Mbps (that is, restoration of transmission speeds is performed). At this time, it is also sufficient that the transmission speed determination unit 13 redetermines the reference transmission speed on the basis of a comparison result by making the respective transmission speed detection units 122 and 123 redetect the transmission speeds.

In addition, when the transmission line 111 is substituted to a 10-Mbps circuit from the 1-Gbps circuit from the structure of FIGS. 1 and 3, the transmission speed detection unit 121 detects the transmission speed after reconnection, and the transmission speed determination unit 13 measures the transmission speed of the newly detected transmission line 111, and each transmission speed of the transmission line 112 and transmission line 113, which are connected now, respectively by making this a trigger. Since the transmission speeds of the transmission lines 112 and 113 are 100 Mbps and 1 Gbps from the above-described example, the transmission speed adjusting unit 14 or 31 controls the transmission speed converting units 125 and 126 to make the transmission speeds of the transmission lines 111 and 113 changed slow from 100 Mbps to 10 Mbps, and 1 Gbps to 10 Mbps, respectively. At this time, it is also sufficient that the transmission speed determination unit 13 redetermines the reference transmission speed on the basis of a comparison result by making the respective transmission speed detection units 122 and 123 redetect the transmission speeds.

When making them operate like these, it becomes possible to make the speed of each transmission line kept stable according to a latest connection state of the transmission lines even when the number of connections or type of transmission lines which are connected to the repeating installation changes. In addition, the predetermined timing is not limited to the detection of a change of the number of connections and type of transmission lines, but it is also sufficient that the transmission speed determination unit 13 sakes the transmission speed determination units 121 to 123 redetect a speed of each transmission line periodically using a timer, not shown, or a clock inputted from the external.

In addition, it is also sufficient to adopt the above-mentioned structure every combination of transmission lines explained in the second embodiment.

Furthermore, although the structure without speed absorption buffer memory is explained in each embodiment, it may be the structure of including speed absorption buffer memory every transmission line. In that case, since it is possible to perform constitution in minimum memory capacity, it is possible sharply to reduce the memory capacity in comparison with the case of a conventional repeating installation.

In addition, each communication system of transmission lines connected to the repeating installation of each embodiment may be any one of Ethernet (registered trademark), a coaxial cable, a power line, wireless, IEEE 1394, a USB, Bluetooth, and a PNA. The present invention is applicable even in the case of a transmission line in any communication system.

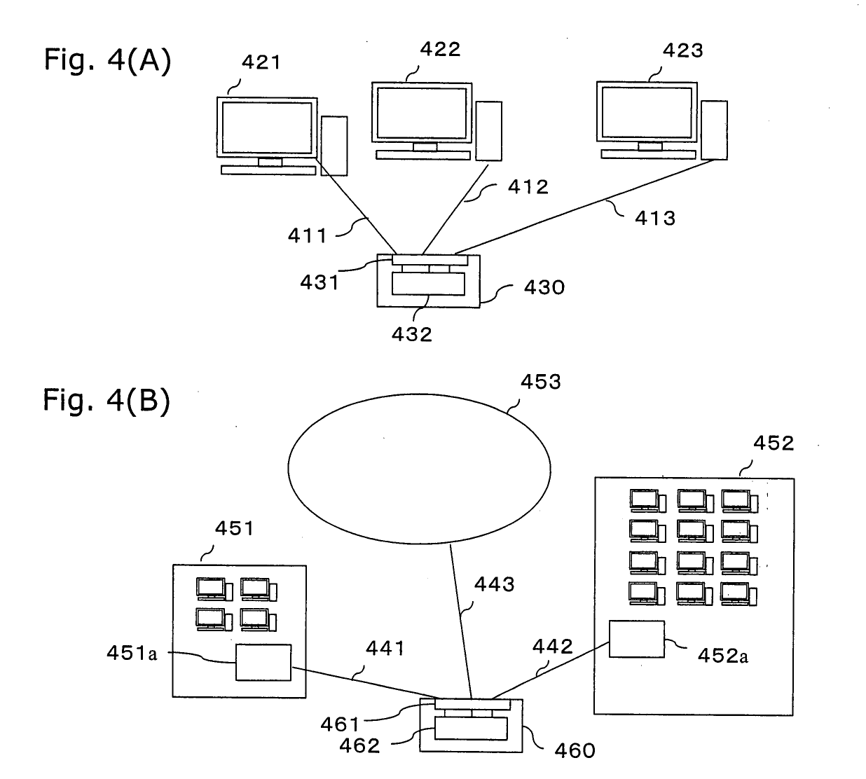

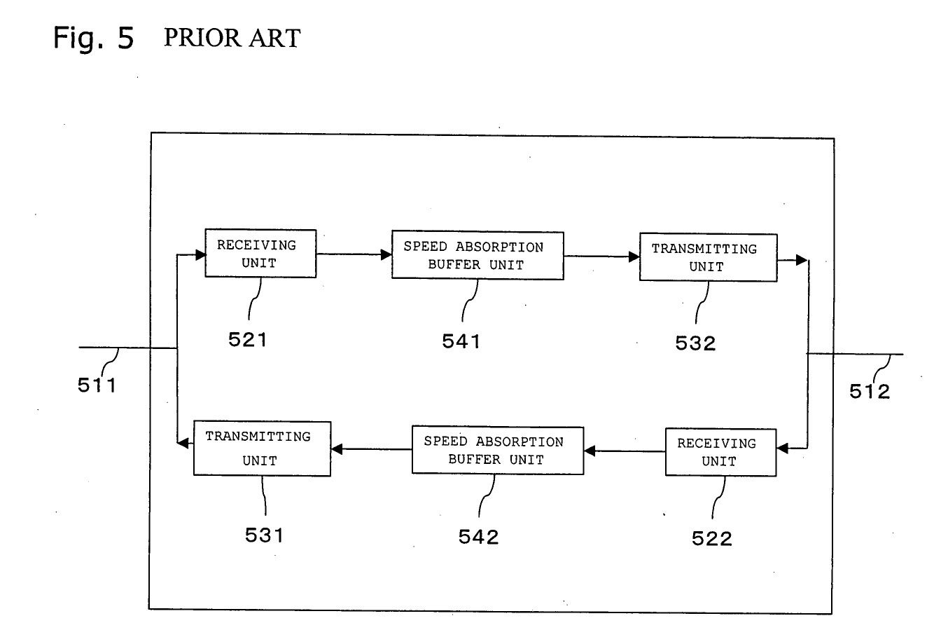

Furthermore, the repeating installation of the present invention can be used for a hub 430 which constitutes a LAN which is constituted of PCs (personal computers) 421 to 423 connected to transmission lines 411 to 413 respectively as shown in FIG. 4(A). In this case, since a repeating installation 432 is connected to an interface 431 of the hub 430, it becomes possible to make data transmission among respective PCs performed stably by adjusting transmission speeds of other transmission lines with corresponding to the slowest transmission line even when there is quality (transmission speed) difference between the transmission lines 411 to 413.

Moreover, as shown in FIG. 4(B), the repeating installation of the present invention can be used for a router 460 which connects a plurality of networks of an intranet A 451 (managed by a server 451a), an intranet B 452 (managed by a server 452a), and the Internet 453 which are connected to the transmission lines 441 to 443, respectively. In this case, since the repeating installation 462 is connected to an interface 461 of the router 460, similarly to the case in FIG. 4(A), it becomes possible to make data transmission among respective networks performed stably by adjusting transmission speeds of other transmission lines with corresponding to the slowest transmission line even when there is quality (transmission speed) difference between the transmission lines 441 to 443. In addition, the interfaces 431 and 461 are equivalent to the connecting means of the present invention, the repeating installations 432 and 462 are equivalent to the relay means of the present invention, and the hub 430 and router 460 are equivalent to the information processing apparatus of the present invention.

Furthermore, a server for network administration, a PC, AV equipment connected to a network, a cooking household appliance, and the like are mentioned as information processing apparatuses equipped with the repeating installation of the present invention. In short, the present invention can be implemented in an apparatus which has a function of connecting a plurality of transmission lines and managing information.

As described above, according to the repeating installation of this first embodiment, when transmission speeds of all the connected transmission lines are detected, a slowest transmission speed is determined, and transmission speeds of transmission lines are adjusted in transmission lines other than the transmission line so as to communicate at the slowest transmission speed or slower, it becomes possible to reduce the buffer memory for speed absorption between different transmission speeds, and to perform stable data communication even in immediate communication like picture data.

In addition, the program of the present invention is a program for making a computer execute all or a part of operation of all or a part of steps of a transmission speed detection step, a transmission speed determination step, and a transmission speed adjusting step in the above-mentioned communication speed adjusting method of the present invention, and a program which operates with collaborating with the computer.

Furthermore, the recording medium of the present invention is a recording medium which recorded a program for making a computer execute all or a part of operation of all or a part of steps of a transmission speed detection step, a transmission speed determination step, and a transmission speed adjusting step in the above-mentioned communication speed adjusting method of the present invention, and is a recording medium which is computer-readable with recording the above-mentioned program, which is read from the recording medium and is used with collaborating with the above-mentioned computer.

Moreover, one utilizing form of the program of the present invention may be an aspect of being recorded in a recording medium which is computer-readable, and operating with collaborating with a computer.

In addition, ROM or the like is included as a recording medium.

Furthermore, the computer of the present invention which is mentioned above may be not only pure hardware such as a CPU, but also firmware, OS, or further, what includes a peripheral device.

Moreover, as described above, the structure of the present invention may be achieved in software or hardware.

As described above, according to the repeating installation of this first embodiment, when transmission speeds of all the connected transmission lines are detected, a slowest transmission speed is determined, and transmission speeds of transmission lines are adjusted in transmission lines other than the transmission line so as to communicate at the slowest transmission speed or slower, it becomes possible to reduce the buffer memory for speed absorption between different transmission speeds, and to perform stable data communication even in immediate communication like picture data. This is also adaptable to an application that high-quality data transmission such as a high definition image is indispensable.

What is claimed is:

1. A repeating installation, comprising:
a transmission speed detection unit detecting respective transmission speeds of a plurality of transmission lines connected to a plurality of communication apparatuses;
a transmission speed determination unit determining a slowest transmission speed among the transmission speeds of the respective transmission lines, which are detected, as a reference transmission speed; and
a transmission speed adjusting unit adjusting a transmission speed of a transmission line, when a detected transmission speed is faster than the reference transmission speed, so as to become a speed equal to or slower than the reference transmission speed.

2. The repeating installation according to claim 1, further comprising:
a transmission speed determination and selection unit which selects combination, in which communication among any communication apparatuses of the plurality of communication apparatuses connected by the plurality of transmission lines to each other is performed, wherein the transmission speed determination unit determines the reference transmission speed for every combination selected; and
wherein the transmission speed adjusting unit adjusts a transmission speed of a transmission line whose detected transmission speed differs from the transmission speed for every combination selected.

3. The repeating installation according to claim 1, wherein the transmission speed adjusting unit adjusts a transmission speed of a transmission line, when a detected transmission speed is faster than the reference transmission speed, at a fastest speed among speeds which is equal to or slower than the reference transmission speed and is settable.

4. The repeating installation according to claim 1, wherein the transmission speed detection unit redetermines the reference transmission speed from transmission speeds of respective transmission lines which are connected, at predetermined timing, and adjusts a transmission speed so as to become a speed equal to or slower than the reference transmission speed when there is a transmission line whose transmission speed is faster than the reference transmission speed.

5. The repeating installation according to claim 4, wherein the predetermined timing is a time of the number of connections or type of the plurality of transmission lines changing.

6. The repeating installation according to claim 1, wherein each communication system of the plurality of transmission lines has any one of ethernet, a coaxial cable, a power line, wireless, IEEE 1394, a USB, Bluetooth, and a PNA.

7. An information processing apparatus, comprising:
connecting means of connecting a plurality of transmission lines; and
relay means of relaying the connecting means mutually, and including:
the repeating installation according to claim 1 as the relay means.

8. A communication speed adjusting method, comprising:
a transmission speed detection step of detecting respective transmission speeds of a plurality of transmission lines connected to a plurality of communication apparatuses;
a transmission speed determination step of determining a slowest transmission speed among the transmission speeds of the respective transmission lines, which are detected, as a reference transmission speed; and
a transmission speed adjusting step of adjusting a transmission speed of a transmission line, when a detected transmission speed is faster than the reference transmission speed, so as to become a speed equal to or slower than the reference transmission speed.

9. A recording medium which can be treated by a computer and is a recording medium recording a program for making the computer function for executing: the transmission speed detection step of detecting respective transmission speeds of a plurality of transmission lines connected to a plurality of communication apparatuses; the transmission speed determination step of determining a slowest transmission speed among the transmission speeds of the respective transmission lines, which are detected, as a reference transmission speed; and the transmission speed adjusting step of adjusting a transmission speed of a transmission line, where a detected transmission speed is faster than the reference transmission speed, so as to become a speed equal to or slower than the reference transmission speed of the communication speed adjusting method according to claim 8.
